(19) United States
(12) Patent Application Publication
(10) Pub. No.: US 2006/0265442 A1
(43) Pub. Date: Nov. 23, 2006

(54) Method and system for controlling a user interface a corresponding device and software devices for implementing the method

(76) Inventor: Saju Palayur, San Diego, CA (US)

Correspondence Address: HARRINGTON & SMITH, LLP, 4 RESEARCH DRIVE, SHELTON, CT, 06484-6212, US

(21) Appl. No.: 10/569,214

(22) PCT Filed: Sep. 23, 2004
(86) PCT No.: PCT/FI04/50135

§ 371 Date: Feb. 24, 2006

(30) Foreign Application Priority Data
Oct. 1, 2003 (FI) 20035170

(51) Int. Cl. G06F 15/00

(52) U.S. Cl. 708/200

(57) ABSTRACT

The invention relates to method for controlling the orientation (O_{info}) of information (INFO) shown for a user (21) on a display (20), in which the information (INFO) has a target orientation (O_{itgt}) In method: the orientation (O_{display}) of the display (20) is defined relative to the information (INFO) shown on the display (20); and if the orientation (O_{info}) of the information (INFO) shown on the display (20) differs from the target orientation (O_{itgt}), then a change of orientation (ΔO) is implemented, as result of which change the orientation (O_{info}) of the information (INFO) shown on the display (20) is made to correspond to the target orientation (O_{itgt}).The orientation (O_{display}) of the display (20) is defined, in a set manner at intervals, by using a camera means (11) connected operationally to the display (20).

The invention relates to method for controlling the orientation of information shown for at least one user using on a display, in which the information has a target orientation, and in which method
the orientation of the display is defined relative to the orientation of the information shown on the display by using camera means connected operationally to the display to form image information, which is analysed to find one or more selected features and to define its/their orientation in the image information and
if the orientation of the information shown on the display differs from the target orientation set for it, then a change of orientation is implemented, as result of which change the orientation of the information shown on the display is made to correspond to the target orientation.

In addition, the invention also relates to a system, a corresponding device, and software devices for implementing the method.

Various multimedia and video-conferencing functions, for example, are nowadays known from portable devices including a display component, such as (but in no way excluding other forms of device) mobile stations and PDA (Personal Digital Assistant) devices. In these, the user observes the information shown on the display of the device while, at the same time, (for example, in a video conference) also appearing themselves as the counter-party, for which purpose the device has camera means connected to it.

In certain situations (but once again in no way excluding other situations), which are connected, for example, to the use of the aforesaid properties, the user may desire in the middle of an operation (such as for example viewing a video clip, or in a conference situation) to change the direction of the display component from the normal, for example, vertical orientation, to some other orientation, for example, a horizontal orientation. In the future, the need for orientation operations for the information shown on a display will significantly increase, due among other reasons to precisely the breakthrough of these properties.

In addition to the above, some of the most recent mobile station models have made different operating orientation alternatives known. Besides the traditional vertically oriented device construction, the device can also be oriented horizontally. In that case, the keyboard of the device can also be adapted to the change of orientation. The displays may also have differences of effect between the vertical and horizontal dimensions, so that a need may arise, for example, to change between the horizontal/vertical orientation of the display, when seeking for the most suitable display position at any one time.

Special situations, such as car driving, are yet another example of a situation requiring such an adaptation of orientation. When driving, the mobile station may be in a disadvantageous position relative to the driver, for example, when attached to the dashboard of a car. In that case, it would be preferable, at least when seeking greater user-friendliness, to adapt the information shown to the mutual positioning of the driver and the mobile station. In practice, this means that it would be preferable to orientate the information shown on the display as appropriately as possible relative to the driver, i.e. it could be shown at an angle, instead of in either the traditional vertical or horizontal orientations.

It is practically impossible to use the prior art to achieve such a change of orientation differing from the rectangular orientation. In such a situation, using the prior art to achieve the operation is further hampered particularly by the fact that in that case the change of orientation is not directed to the device, precisely from which, according to the prior art, a change of orientation of the display relative to a reference point set for it is detected.

One first solution representing the prior art for reorienting a device and particularly its display component is to perform a change of orientation of the information shown on the display of the device, from the device's menu settings. In that case, the orientation of the display component of the device can be changed from, for example, a vertically oriented display defined in set manner (for example, the narrower sides of the display are then at the tope and bottom edges of the display, relative to the viewer) to a horizontally oriented display defined in a set manner (for example, the narrower sides of the display are then at the left and right-hand sides of the display, relative to the viewer).

A change of orientation performed from menu settings may demand the user to wade, even deeply, through the menu hierarchy, before finding the item achieving the desired operation. However, it is in no way user-friendly to have to perform this operation, for example, in the middle of viewing a multimedia clip or participating in a videoconference. In addition, a change of orientation made from a menu setting may be limited to previously preset information orientation changes. Examples of this are, for instance, the ability to change the orientation of the information shown on the display only through angles of 90 or 180 degrees.

Further, numerous more developed solutions for resolving the problems relating to the aforementioned operation and even, for example, for performing it completely automatically, are known from the prior art. Some examples of such solutions include various angle/tilt probes/sensors/switches, limit switches, acceleration sensors, and sensors for flap opening. These can be implemented as mechanically or electrically, or even as combinations of both. In the device solutions based on tilt/angle measurement, the orientation of the device and particularly its display component is defined relative to a set reference point. The reference point is then the earth, as their operating principle is based on the effect of gravity.

One reference concerning these is the WO publication 01/43473 (TELBIRD LTD), in the solution disclosed in which micro-machined tilt meters located in the device are used.

Mechanical and semi-mechanical sensor solutions are, however, difficult to implement, for example, in portable devices. They increase the manufacturing costs of the devices and thus also their consumer price. In addition, their use always brings a certain danger of breakage, in connection with which the replacement of a broken sensor is not worth while, or even in some cases possible, due to the high degree of integration in the devices.

The operation of electromechanical types of sensor may also be uncertain in specific orientation positions of the device. Also in addition, it should be stated that non-linear properties are associated with the orientation definitions of these solutions. An example of this is tilt measurement, in which the signal depicting the orientation of the device/display may have the shape of a sine curve.

Besides the fact that the sensor solutions described above are difficult and disadvantageous to implement, for example, in portable devices, they nearly always require a physical change in the orientation of the device relative to a set reference point (the earth), relative to which the orientation is defined. If, for example, when driving a car, the user of the device is in a disadvantageous position relative to the display of a mobile station and to the information shown on it, the sensor solutions described above will not react in any way to the situation. Also a change of orientation made from a menu setting, as a fixed quantity, will not, in such a situation, be able to provide a solution for orientating the information in an appropriate manner, taking the operating situation into account. In such situations, in which the orientation of the device is, for example, fixed, it is more appropriate for the user to keep their head continuously tilted, in order to orientate the information, which is neither a pleasant, nor a comfortable way of using the device.

A solution, in which the orientation of the display is defined from image information created using camera means arranged operationally in connection with the display, is known from international (PCT) patent publication WO-01/88679 (Mathengine PLC). For example, the head of the person using the device can be sought from the image information and, even more particularly, his/hers eye line can be defined in the image information. The solution disclosed in the publication largely emphasizes 3-D virtual applications, which are generally for a single person. If several people are next to the device, as may be the case, for example, with mobile stations, when they are used to view, for example, video clips, the functionality defining the orientation of the display will no longer be able to decide in which position the display is. Further, for example, the ‘real-timeness’ of 3-D applications requires the orientation definition to be made essentially continuously. As a result, the image information must be detected continuously, for example, at the detection frequency using in the viewfinder image. As a result, the continuous imaging and orientation definition from the image information consume a vast amount of device resources. Essentially continuous imaging, which is also performed at the known imaging frequency, also has a considerable effect on the device's power consumption.

The present invention is intended to create a new type of method and system for controlling the orientation of information shown on the display. The characteristic features of the method according to the invention are stated in the accompanying Claim 1 and those of the system in Claim 8. In addition, the invention also relates to a corresponding device, the characteristic features of which are stated in Claim 13 and software devices for implementing the method, the characteristic features of which are stated in Claim 17.

The invention is characterized by the fact that the orientation of the information shown for at least one user on the display is controlled in such a way that the information is always correctly oriented relative to the user. To implement this, camera means are connected to the display or, in general, to the device including the display, which camera means are used to create image information for defining the orientation of the display. The orientation of the display may be defined, for example, relative to a fixed point selected from the image subject of the image information. Once the orientation of the display is known, it is possible, on this basis, to orientate the information shown on it appropriately, relative to one or more users.

According to one embodiment, in the method, at least one user of the device, for example, who is imaged by the camera means, can, surprisingly, be selected as the image subject of the image information. The image information is analysed, in order to find one or several selected features from the image subject, which can preferably be a facial feature of at least one user. Once the selected feature, which according to one embodiment can be, for example, the eye points of at least one user and the eye line formed by them, is found, the orientation of at least one user relative to the display component can be defined.

After this, the orientation of the display component relative, for example, to the defined reference point, i.e. for example relative to the user, can be decided from the orientation of the feature in the image information. Once the orientation of the display component relative to the defined reference point or in generally relative to the orientation of the information shown on it is known, then it can also be used as a basis for orienting the information shown on the display component highly appropriately, relative to at least one user.

According to one embodiment, the state of the orientation of the display component can be defined in a set manner at intervals. Though the continuous definition of the orientation in this way is not essential, it is certainly possible. However, it can be performed at a lower detection frequency than in conventional viewfinder/video imaging. The use of such a definition at intervals achieves, among other things, saving in the device's current consumption and in its general processing power, on which the application of the method according to the invention does not, however, place a loading that is in any way unreasonable.

If the definition at intervals of the orientation is performed, for example, according to one embodiment, in such a way that it takes place once every 1-5 seconds, preferably, for example, at intervals of 2-3 seconds, then such a non-continuous recognition will not substantially affect the operability of the method or the comfort of using the device, instead the orientation of the information will still continue to adapt to the orientation of the display component at a reasonably rapid pace. The savings in the power consumption arising from the method are, however, dramatic, when compared, for example, to continuous imaging, such as viewfinder imaging.

Large numbers of algorithms used to analyse the image information, for example, to find facial-features, such as, for example, the eye points, and to define, from the image information, the eye line defined from them, are known from, the field of facial-feature algorithmics, their selection being in no way restricted in the method according to the invention. In addition, the definition, in the image information, of the orientation of the image subject found from the image information and the orientation on this basis of the information shown on the display component, can be performed using numerous different algorithms and selections of the reference orientation/reference point.

The method, system, and software devices according to the invention can be carried out relatively simply integrated in both existing devices, which can be portable according to one embodiment, and also in those presently being designed. The method can be implemented purely on a software level, but, on the other hand, also on a hardware level, or as a combination of both. The most preferable manner of implementation appears, however, to be a purely software implementation, because in that case, for example, the mechanisms that appear in the prior art are totally eliminated, thus reducing the manufacturing costs of the device and therefore also the price.

The solution according to the invention causes almost no increase in the complexity of a device including camera means, to an extent that would noticeably interfere with, for example, the processing power or memory operation of devices.

Other features of the method, system, device, and software devices according to the invention will be apparent from the accompanying Claims while additional advantages that can be achieved are itemized in the description portion.

In the following, the method, system, device, and software devices for implementing the method, according to the invention, which are not restricted to the embodiments disclosed in the following, are examined in greater detail with reference to the accompanying figures, in which

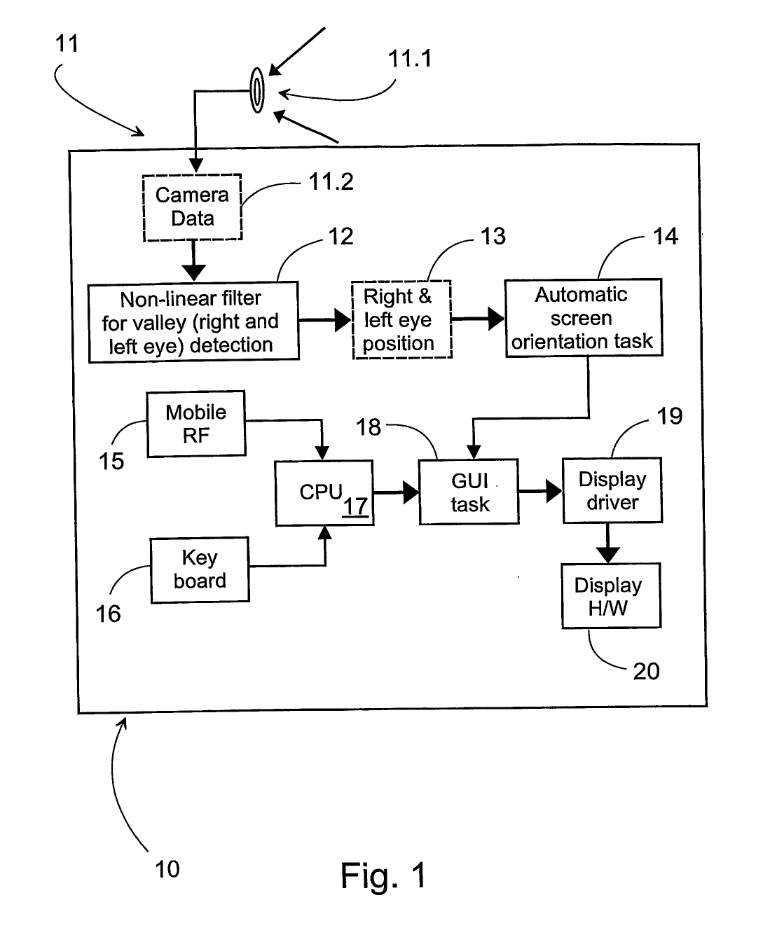

FIG. 1 shows a schematic diagram of one example of a system according to the invention, arranged in a portable device,

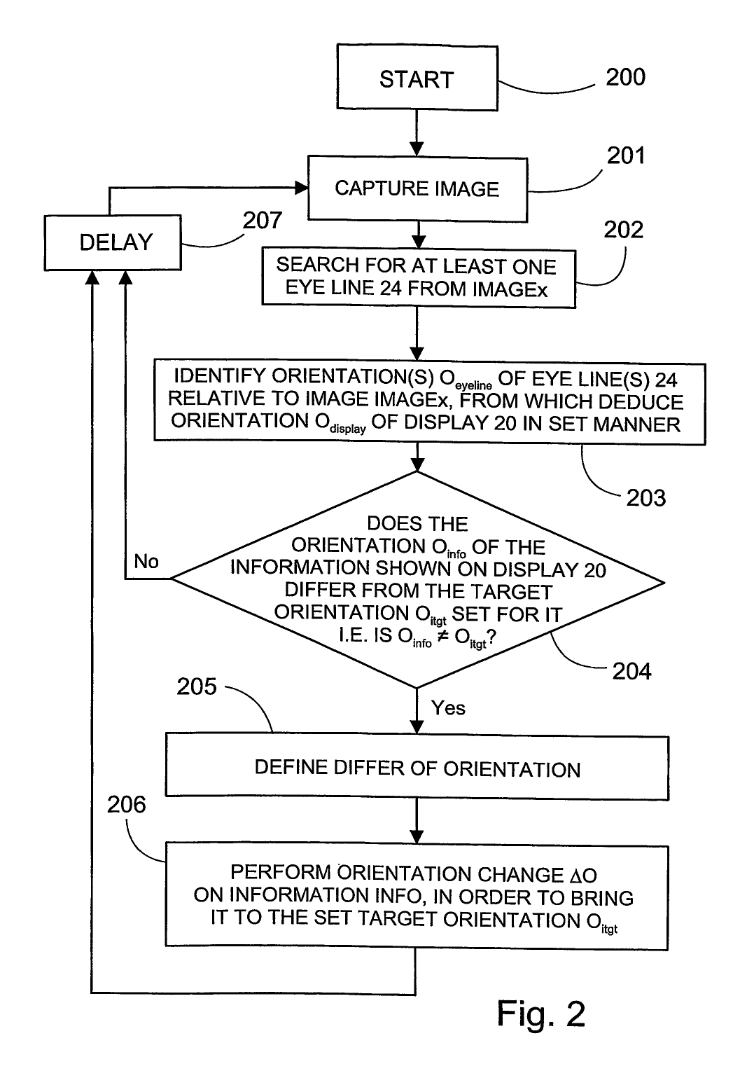

FIG. 2 shows a flow diagram of one example of the method according to the invention,

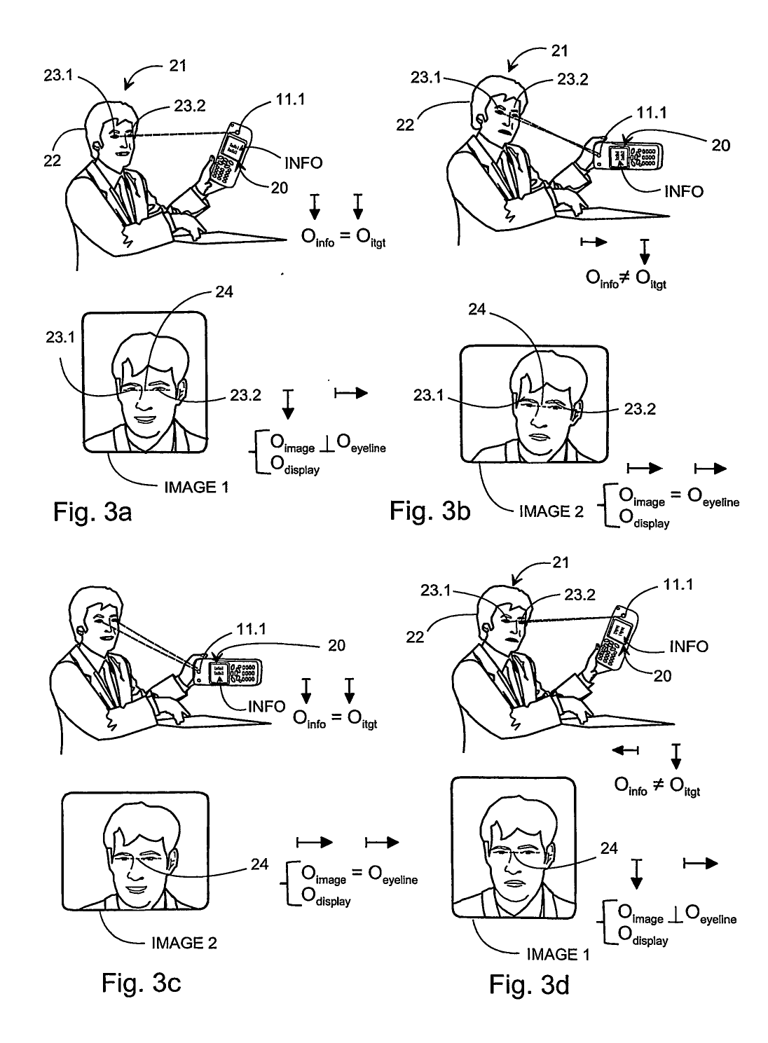

FIGS. 3a-3d show a first embodiment of the method according to the invention, and

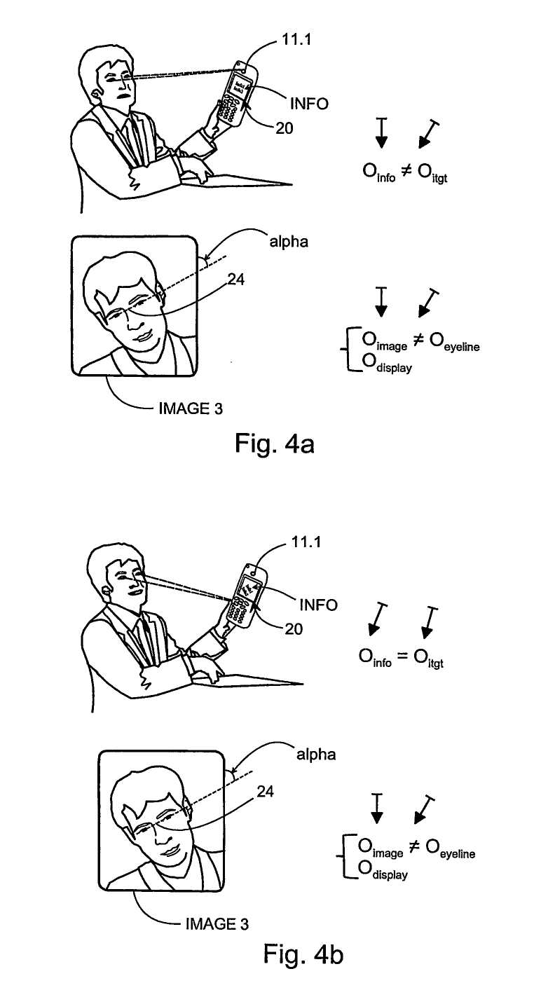

FIGS. 4a and 4b show a second embodiment of the method according to the invention.

FIG. 1 shows one example of the system according to the invention, in a portable device 10, which in the following is depicted in the form of an embodiment in a mobile station. It should be noted, that the category of portable hand-held devices, to which the method and system according to the invention can be applied, is very extensive. Other examples of such portable devices include PDA-type devices (for example, Palm, Vizor), palm computers, smart phones, portable game consoles, music-player devices, and digital cameras. However, the devices according to the invention have the common feature of including, or being able to have somehow attached to them camera means 11 for creating image information IMAGEx. The device can also be a videoconference equipment which is arranged as fixed and in which the speaking party is recognised, for example, by a microphone arrangement.

The mobile station 10 shown in FIG. 1 can be of a type that is, as such, known, components of which, such as the transmitter/receiver component 15, that are irrelevant in terms of the invention, need not be described in greater detail in this connection. The mobile station 10 includes a digital imaging chain 11, which can include camera sensor means 11.1 that are, as such, known, with lenses and an, as such, known type of image-processing chain 11.2, which is arranged to process and produce digital still and/or video image information IMAGEx.

The actual physical totality including the camera sensor 11.1 can be either permanently fitted in the device 10 or, in generally, in the connection of the display 20 of the device 10 or detachable. In addition, the sensor 11.1 can also be able to be aimed. According to one embodiment, the camera sensor 11.1 is aimed at, or at least arranged to be able to be aimed at at least one user 21 of the device 10, to permit the preferred embodiments of the method according to the invention. In the case of mobile stations, the display 20 and the camera 11.1 will then be on the same side of the device 10.

The operations of the device 10 can be controlled using a processor unit DSP/CPU 17, by means of which the device's 10 user interface GUI 18, among other things, is controlled. Further, the user interface 18 is used to control the display driver 19, which in turn controls the operation of the physical display component 20 and the information INFO shown on it. In addition, the device 10 can also include a keyboard 16.

Various functionalities that permit the method are arranged in the device 10, in order to implement the method according to the invention. A selected analysis algorithm functionality 12 for the image information IMAGEx is connected to the image-processing chain 11.2. According to one embodiment, the algorithm functionality 12 can be of a type, by means of which one or more selected features 24 are sought from the image information IMAGEx.

If the camera sensor 11.1 is aimed appropriately in terms of the method, i.e. it is aimed at at least one user 21 examining the display 20 of the device 10, then at least the head 22 of the user 21 will usually be as an image subject in the image information IMAGEx created by the camera sensor 11.1. The selected facial features can then be sought from the head 22 of the user 21, from which one or more selected features 24 or the combinations of them can then be sought or defined.

One first example of such a facial feature can be the eye points 23.1, 23.2 of the user 21. There exist numerous different filtering algorithms, by means of which the user's 21 eye points 23.1, 23.2, or even the eyes in them, can be identified. The eye points 23.1, 23.2 can be identified, for example, by using a selected non-linear filtering algorithm 12, by means of which the valleys at the positions of both eyes can be found.

Further, the device 10 also includes, in the case according to the embodiment, a functionality 13, for identifying the orientation O_{eyeline} of the eye points 23.1, 23.1, or generally the feature that they form, in this case the eye line 24, in the image information IMAGEx created by the camera means 11.1. This functionality 13 is followed by a functionality 14, by means of which the information INFO shown on the display 14 can be oriented according to the orientation O_{eyeline} of the feature 24 identified from the image information IMAGEx, so that it will be appropriate to each current operating situation. This means that the orientation O_{display} Of the display 20 can be identified from the orientation O_{eyeline} of the feature 24 in the image information (IMAGEx) and then the information INFO shown by the display 20 is oriented to be appropriately in relation to the user 21.

The orientation functionality 14 can be used to control directly the corresponding functionality 18 handling the tasks of the user interface GUI, which performs a corresponding adaptation operation to orientate the information INFO according to the orientation O_{display} defined for the display 20 of the device 10.

FIG. 2 shows a flow diagram of an example of the method according to the invention. The orientation of the information INFO on the display component 20 of the device 10 can be automated in the operating procedures of the device 10. On the other hand, it can also be an operation that can be set optionally, so that it can be activated in a suitable manner, for example, from the user interface GUI 18 of the device 10. Further, the activation can also be connected to some particular operation stage relating to the use of the device 10, such as, for example, in connection with the activation of videoconferencing or multimedia functions.

When the method according to the invention is active in the device 10 (stage 200), a digital image IMAGEx is captured either continuously or at set intervals by the camera sensor 11.1 (stage 201). Because the camera sensor 11.1 is preferably arranged in the manner already described above to be aimed towards the user 21 of the device 10, the subject of the image of the image information IMAGEx that it creates is, for example, the head 22 of at least one user 21. Due to this, for example, the head 22 of the user 21 can be according to a one embodiment set as the reference point when defining each orientation state of the display 20 and the information INFO, relative to the user 21. Thus, the orientations O_{display}, O_{info} of the display component 20 and the information INFO that it shows can be defined in relation to the orientation of the head 22 of the user 21, which orientation of the head 22 is in turn obtained by defining in a set manner the orientation O_{eyeline} of the selected feature 24, relative to the orientation O_{image} of the image information IMAGEx defined in a set manner.

Next, the image information IMAGE1, IMAGE2 is analysed in order to find one or more features 24 from the image subject 22, using the functionality 12 (stage 202). The feature 24 can be, for example, a geometrical. The analysis can take place using, for example, one or more selected facial-feature analysis algorithms. In a rough sense, facial-feature analysis is a one procedure in which, for example, eye, nose, and mouth positions can be positioned from the image information IMAGEx.

In the cases shown in the embodiments, this selected feature is the eye line 24 formed by the eyes 23.1, 23.2 of the user 21. Other possible features can be, for example, the geometric rotation image (for example, an ellipse) formed by the head 22 of the user 21, from which the orientation of the selected reference point 22 can be identified quite clearly. Further, the nostrils that are found from the face can also be selected as an identifying feature, which is a matter once again of the nostril line defined by them, or of the mouth, or of some combination of these features. There are thus numerous ways of selecting the features to be identified.

One way of implementing the facial feature analysis 12 is based on the fact that deep valleys are formed at these specific points on the face (which appear as darker areas of shadow relative to the rest of the face), which can then be identified on the basis of luminance values. The location of the valleys can thus be detected from the image information IMAGEx by using software filtering. Non-linear filtering can also be used to identify valleys in the pre-processing stage of the definition of the facial features. Some examples relating to facial-feature analysis are given in the references [1] and [2] at the end of the description portion. To one versed in the art, the implementation of facial-feature analysis in connection with the method according to the invention is an obvious procedural operation, and therefore there is no reason to describe it in greater detail in this connection.

Once the selected facial features 23.1, 23.2 have been found from the image information IMAGEx, the next step is to use the functionality 13 to define their orientation O_{eyeline} relative to the image information IMAGEx (stage 203).

Once the orientation O_{eyeline} of the feature 24 in the image information IMAGEx has been defined, it is possible in a set manner to also decide from it the orientation O_{display} of the display component 20, relative to the reference point, i.e. the image subject 22, which is thus the head 22 of the user 21. Naturally, this depends on the selected reference points, on their defined features, and on their orientations, and generally on the selected orientation directions.

The target orientation O_{itgt} is set for the information INFO shown on the display 20 in relation to the selected reference point 22, in order to orientate the information INFO on the display 20 in the most appropriate manner, according to the orientation O_{display} of the display 20. The target orientation O_{itgt} can be fixed according to the reference point 22 which defines the orientations O_{display}, O_{info} of the display component 20 and the information INFO, in which case the target orientation O_{itgt} thus corresponds to the orientation of the head 22 of the user 21 of the device 10, relative to the device 10.

Further, once the orientation O_{display} of the display 20 relative to the selected reference point 22 is known, it is then also possible to decide on the orientation O_{info} of the information INFO shown of the display 20, relative to the selected reference point 22. This is so that the orientation O_{info} on the display 20 of the device 10 of the information INFO will be known at all times to the functionalities 18, 19 controlling the display 20 of the device 10.

In stage 204 a comparison operation is performed. If the orientation O_{info} of the information INFO shown on the display component 20, relative to the selected reference point 22 differs in a set manner from the target orientation O_{itgt} set for it, then in that case a change of orientation ΔO is performed on the information INFO shown on the display component 20. Next, it is possible to define the orientation change ΔO required (stage 205). As a result of the change, the orientation O_{info} of the information INFO shown on the display component 20 is made to correspond to the target orientation O_{itgt} set for it, relative to the selected reference point 22 (stage 206).

If there is no difference, according to that set, between the orientation O_{info} of the information INFO and the target orientation O_{itgt} of the information INFO, then the orientation O_{info} of the information INFO shown on the display 20 is appropriate, i.e. in this case, it is oriented at right angles to the eye line 24 of the user 21. After ascertaining this, it is possible to move, after a possible delay stage (207) (described later), back to the stage (201), in which new image information IMAGEx is captured, in order to investigate the orientation relation between the user 21 and the display component 20 of the device 10. A difference according to that set, in the orientation of the information INFO can be defined as being, for example, a situation in which the eye line 24 of the user 21 is not quite at right angles to the vertical orientation of the head 22 (i.e. the eyes are at a bit different level to the cross-section of the head) does not yet require measures to reorient the information INFO shown by the display component 20.

The follows describes in a very general level a C-pseudocode example of the orientation algorithm used in the method according to the invention, with reference to the embodiments of FIGS. 3-4. In the system according to the invention, such a software implementation can be, for example, in functionality 14, by means of which the orientation settings tasks of the display 20 are handled automatically. In the embodiments, only the vertical and horizontal orientations are dealt with. However, it will be obvious to one versed in the art to also apply the code to other orientations, to then also take into account the orientations directions of the display component 20, relative to the selected reference point 22 (horizontal clockwise/horizontal anticlockwise & vertical normal/vertical up-down).

At first, some orientation fixing selections can be made in the code, which are necessary to control the orientations:

if (O_{image}==vertical)→O_{display}=vertical;

if (O_{image}==horizontal)→O_{display} horizontal;

With reference to FIGS. 3a-4b, after such definitions, if the camera 11.1 has been used to capture image information IMAGE1 and the image information IMAGE1 is in a vertical (portrait) position, the device 10 too is then in a vertical position relative to the selected reference point, i.e. in this case the head 22 of the user 21. Correspondingly, if the image information IMAGE 2 is in a horizontal (landscape) position, then on the basis of the set orientation fixing definitions the device 10 too is in a horizontal position, relative to the selected reference point 22.

Next, some initialization definitions can be made:

set O_{itgt}, O_{info}=vertical;

After such initialization definitions, the target orientation O_{itgt} of the information INFO shown on the display 20, relative to the selected reference point 22, is vertical, as is also the initial setting of the orientation O_{info} of the information INFO. Next, using the camera means 11, 11.1 (i) image information IMAGEx is captured, (ii) the image information IMAGEx is analysed in order to find the selected geometric feature 24 and (iii) to define its orientation O_{eyeline} in the image information IMAGEx:

(i) capture_image(IMAGE);

(ii) detect_eyepoints(IMAGE);

(iii) detect_eyeline(IMAGE, eyepoints);

As the next stage, it is possible to examine the orientation O_{eyeline} of the selected geometric feature 22 defined from the image information IMAGEx (x=1−3) captured by the camera 11.1, relative to the orientation definitions O_{image} of the image information and on the basis of this to direct the changing operations to the O_{info} of the information INFO shown on the display 20 in relation to the selected reference point 22. In the light of the described two-stage embodiment, the orientation O_{display} of the display 20 can now be either vertical or horizontal, relative to the selected reference point, i.e. the user 21. In the first stage of the embodiment, it is possible to investigate whether:

$$If ( ( {O}_{eyeline} ⊥ {O}_{image} ) \&\& ( {O}_{display} != {O}_{info} ) ) \{ set\_orientation ( {O}_{display} , {O}_{info} , {O}_{itgt} ) ; \}$$

In other words, this stage signifies that, due to the initial definitions made in the initial stage of the code, and due to the orientation nature of the selected geometric feature 24 of the reference point 22, the situation is that shown in FIG. 3a. In this case, the device 10 and also, due to the orientation definitions made, its display component 20, are vertical relative to the user. When the camera means 11, 11.1 are used to capture an image IMAGE1 of the user 21 of the device 10 in a vertical position, then (due also to the orientation definition of the image IMAGE1 made in the initial settings) the orientation O_{eyeline} of the eye line 24 of the user 21 found from the image IMAGE1 is at right angles relative to the orientation O_{image} of the image IMAGE1.

In this case, the latter condition examination is, however, not valid. This is because, due to the orientation setting made, the orientation O_{image} of the image IMAGE1 is identified as being vertical, as a result of which the definition made already in the initialization stage is that O_{display} is also vertical relative to the reference point 22. In connection with these conclusions, if allowance is also made for the fact that the orientation O_{info} of the information INFO was also initialized in the initial stage as being vertical relative to the reference point 22, then the latter condition examination is not valid, and the information INFO is already displayed in the display component 20 in the correct orientation, i.e. vertical relative to the selected reference point 22.

However, when this condition examination stage is applied to the situation shown in FIG. 3d, then in that case the latter condition examination is also valid. In FIG. 3d, the device 10 is brought from the horizontal position shown in FIG. 3c (in which the orientation O_{info} of the information INFO has been correct, relative to the user 21) to the vertical position relative to the user 21. As a result of this, the orientation O_{info} of the information INFO shown on the display 20 relative to the user 21 is still horizontal, i.e. it differs from the target orientation O_{itgt}. Now the latter condition of the condition examination is also true, because the orientation O_{display} of the display 20 differs in the set manner from the orientation O_{info} of the information INFO. As a result of this, the orientation procedure for the information is repeated on the display 20 (set_orientation), which it is, however, unnecessary to describe in greater detail, because its performance will be obvious to one versed in the art. As a result of the operation, the situation shown in FIG. 3a is reached.

The procedure also includes a second if-examination stage, which can be formed, for example, as follows, on the basis of the previously made initial setting selections and fixings:

$$If ( ( {O}_{eyeline} \vert \vert {O}_{image} ) \&\& ( {O}_{display} == {O}_{info} ) ) \{ set\_orientation ( {O}_{display} , {O}_{info} , {O}_{itgt} ) ; \}$$

This can be used to deal with, for example, the situation shown in FIG. 3b. In this case the device 10 and at the same time thus also its display 20 are turned, relative to the user 21, from the vertical position shown in FIG. 3a to the horizontal position (vertical→horizontal). As a result of this change of orientation, the information INFO shown on the display 20 is, relative to the user 21, oriented horizontally, i.e. it is now in the wrong position.

Now it is detected in the if partition, that the orientation O_{eyeline} of the eye line 24 of the user 21 in the image IMAGE2 is parallel to the image orientation O_{image} defined in the initial setting. From this, it can be deduced (on the basis of the initial settings that have been made), that the display component 20 of the device 10 is horizontal relative to the user 21. Further, when examining the latter condition in the if partition, it is noticed that the direction of the display 20 relative to the reference point, i.e. the user 21 is horizontal and parallel to the information INFO shown in the display 20. This means that the information INFO is then not in the target orientation O_{itgt} set for it, and therefore the reorientation procedure (set_orientation) must be performed on the display 20 for the information INFO. This is not, however, described in greater detail, because its performance will be obvious to one versed in the art and can be performed in numerous different ways in the display driver entity 19. In this case, the end result is the situation shown in FIG. 3c.

Further, according to one embodiment, an examination of other that only rectangular orientation changes (portrait/landscape) can be introduced, if only the display component 20 of the device 10 supports such incrementally changing orientations FIGS. 4a and 4b show an example of a situation relating to such an embodiment. According to one embodiment, this can be presented on pseudocode level, for example in such a way that:

define_orientation_degree(O_{image}, O_{eyeline});

Roughly, in this procedure (without, however, describing it in greater detail) the degree of rotation a of the eye line can be defined, relative, for example, to the orientation O_{image} (portrait/landscape) of the selected image IMAGE3. From this it is possible to ascertain the position of the user 21, relative to the device 10 and also thus to the display 20. The required orientation change can be performed using the same principle as already in the earlier stages, however, with, for example, the number of degrees between the image orientation O_{image} and the orientation O_{eyeline} of the geometric feature 24 as a possible additional parameter.

As still one more final stage, there can be a delay interval in the procedure:

delay (2 seconds);

after which a return can be made to the image-capture stage (capture_image).

If several people are present next to the device 10 examining the information INFO shown on the display 20, then several faces may be found in the image information IMAGEx. In that case, it will be possible to define from the image information IMAGEx, for example, the average orientation of the faces and consequently of the eye lines 24 defined from them, to be found in it. This is set to correspond to the feature defining the orientation O_{display} of the display 20. On the basis of the orientation O_{eyeline} of this average feature 24, the orientation O_{display} of the display 20 can be defined and, on its basis, the information INFO can be oriented on the display 20 to a suitable position. Another possibility is to orient the information INFO on the display 20 to, for example, a default orientation, if the orientation of the display 20 cannot be explicitly defined using the functionality.

It should be noted, that the above example of identifying the current orientation O_{display} of the display 20 of the device 10, from the image information IMAGEx, relative to a reference point 22, is only very much by way of an example. The various image information analysis algorithms, and the identifications and manipulations of objects defined from them will be obvious to one versed in the art. In addition, in digital image processing, there is not necessary any need to apply the image information landscape/portrait orientation manner, instead the image information IMAGEx produced by the sensor 11.1 can be equally ‘wide’ in all directions. In that case, one side of the image sensor 11.1 can be selected as the reference side, relative to which the orientations of the display component 20 and the selected feature 24 can be defined.

Generally it is enough to define the orientation O_{display} of the display 20 relate to the information INFO shown on the display 20. If the orientation O_{display} of the display 20 may be defined, and the current orientation O_{info} of the information INFO shown on the display 20 relate to the display 20 is known, then consequence of this the orientation O_{info} of the information INFO relate to the target orientation O_{itgt} set for it can be concluded. Hence, the method according to the invention can also be applied in such a way that there would be need to use the reference point way of thinking as described above.

Due to this, more highly developed solutions for defining the orientation of a selected feature, from image information IMAGEx produced by a camera sensor 11.1, will be also be obvious to one versed in the art, so that they can be based, for example, on the identification of an orientation formed from the co-ordinates of the sensor matrix 11.1

As already stated earlier, instead of the essentially continuously performed identification of the orientation of the display component 20 of the device 10, identification can also take place in the set manner at intervals. According to on embodiment, the identification of the orientation can be performed at 1-5-second intervals, for example at 2-4-second intervals, preferably at 2-3-second intervals.

The use of intervals can also be applied to many different functionalities. According to a first embodiment, it can be bound to the clock frequency of the processor 17, or according to a second embodiment bound to the viewing of a multimedia clip, or to a videoconferencing functionality. The preceding operating situations can also affect the use of intervals, so that it can be altered in the middle of using the device 10. If the device 10 has been used for a long time in the same orientation, and its orientation is suddenly changed, then the frequency of the definition of the orientation can be increased, because a return to the preceding longer term orientation may soon take place.

The use of such a somewhat delayed or otherwise less frequent performance of the orientation, carried out using the detection of the image information IMAGEx and/or the orientation, has practically no significant disadvantage to the usability of the device 10. Instead, such imaging and/or detection at intervals, for example, performed using imaging and/or detection that is less frequent than the continuous-detection frequency of the camera means 17, does achieve the advantage, for example, of lower current consumption compared to the imaging frequencies used, for example, in continuous viewfinder or video-imaging (=for example, 15-30 frames per second).

Instead of individual frame capture or substantially less frequent continuous detection (for example, 1-5 (10) frames per second), continuous imaging that is, as such, at known frequencies, can be performed less frequently, for example, at set intervals of time. Thus, imaging according to the prior art is performed, for example, for one second in the aforementioned period of, for example, 2-4 seconds. On the other hand, the capture of only a few image frames in a single period may also be considered. However, probably at least a few image frames will be required for a single imaging session, in order to adjust the camera parameters suitably for forming the image information IMAGEx to be analysed.

As yet another additional advantage, the saving of device resources (DSP/CPU) for the other operations of the device 10 is achieved. Thus, processor powerly 30-95%, for example, 50-80%, however preferably less than 90% (>80%) of the device resources (DSP/CPU) can be reserved for orientation definition/imaging. Such a definition performed at less frequent intervals is particularly significant in the case of portable devices, for example, mobile stations and digital cameras, which are characterized by a limited processing capability and power capacity.

It must be understood that the above description and the related figures are only intended to illustrate the present invention. The invention is thus in no way restricted to only the embodiments described above, or those stated in the Claims, instead many different variations and adaptations of the invention, which are possible within the scope of the inventive idea defined in the accompanying Claims, will be obvious to one versed in the art.

### REFERENCES

[1] Ru-Shang Wang and Yao Wang, “Facial Feature Extraction and Tracking in Video Sequences”, IEEE Signal Processing Society 1997 Workshop on Multimedia Signal Processing, Jun. 23-25, 1997, Princeton N.J., USA Electronic Proceedings. pp. 233-238.

[2] Richard Fateman, Paul Debevec, “A Neural Network for Facial Feature Location”, CS283 Course Project, UC Berkeley, USA.

1. A method for controlling the orientation (O_{info}) of information (INFO) shown for at least one user on a display, in which the information (INFO) has a target orientation (O_{itgt}), and in which method
the orientation (O_{display}) of the display is defined relative to the orientation (O_{info}) of the information (INFO) shown on the display, by using at least viewfinder imaging enabling camera means connected operationally to the display to form image information (IMAGEx), which is analysed to find one or more selected features and to define its/their orientation (O_{eyeline}) in the image information (IMAGEx) and
if the orientation (O_{info}) of the information (INFO) shown on the display differs from the target orientation (O_{itgt}) set for it, then a change of orientation (ΔO) is implemented, as result of which change the orientation (O_{info}) of the information (INFO) shown on the display is made to correspond to the target orientation (O_{itgt}),
characterized in that the definition of the orientation is performed at intervals, in such a way that the camera means are used to form image information (IMAGEx) for the purpose of the definition of the orientation less frequently, relative to their continuous viewfinder detection frequency.

2. A method according to claim 1, characterized in that the head of at least one user is selected as the image subject of the image information (IMAGEx).

3. A method according to claim 2, characterized in that the selected feature comprises facial features of at least one user, which are analysed using facial feature analysis, in order to find one or more facial features.

4. A method according to claim 3, characterized in that the, facial feature is, for example, the eye points of at least one user, in which the selected feature is, for example, the eye line defined by the eye points.

5. A method according to claim 1, characterized in that the definition of the orientation pe^{r}formed at intervals of 1-5 seconds, for example, intervals of 2-4 seconds, preferably intervals of 2-3 seconds.

6. A method according to claim 1, characterized in that 30-95%, for example, 50-80%, however, preferably less than 90% of the device resources are reserved for the definition of the orientation.

7. A method according to claim 1, characterized in that at least two users are detected from the image information (IMAGEx), from the facial features of whom an average value is defined, which is set to correspond to the said feature.

8. A system for controlling the orientation (O_{info}) of the information (INFO) shown for at least one user on a display in a device in which the system includes
a display arranged in connection with the vice for showing the information (INFO),
camera means arranged operationally in connection with the device and enabling at least viewfinder imaging, for forming image information (IMAGEx), from which image information (IMAGEx) the orientation (O_{display}) of the display is arranged to be defined relative to the orientation (O_{info}) of the information (INFO) shown on the display,
means for changing the orientation (O_{info}) of the information (INFO) shown on the display to the target orientation (O_{itgt}) set for it, if the orientation (O_{display}) of the display and the orientation (O_{info}) of the information (INFO) shown on the display differ from each other in a set manner,
characterized in that the definition of the orientation of the display is arranged to be performed at intervals, in such a way that the camera means are arranged to form image information (IMAGEx) for the purpose of the definition of the orientation less frequently, relative to their continuous viewfinder detection frequency.

9. A system according to claim 8, characterized in that the image subject of the image information (IMAGEx) is selected as at least one user being next to the device, in which case the system includes a facial-feature analysis functionality for finding parts of the face of one or several users from the image information (IMAGEx), in which defined feature, relative to the image information (IMAGEx), the orientation (O_{display}) of said display is arranged to be defined.

10. A system according to claim 8, characterized in that the definition of the orientation is arranged to be performed at intervals of 1-5 seconds, for example, intervals of 2-4 seconds, preferably intervals of 2-3 seconds.

11. A system according to of claim 8, characterized in that 30-95%, for example, 50-80%, however, preferably less than 90% of the device resources are arranged to be used for the definition of the orientation.

12. A system according to claim 8, characterized in that at least two users are arranged to be detected from the image information (IMAGEx), from the facial features of whom an average value is arranged to be defined, which is arranged to be set to correspond to the said feature.

13. A portable device, in connection with which are arranged
a display for showing information (INFO),
camera means arranged operationally in connection with the device and enabling at least viewfinder imaging for forming image information (IMAGEx), from which image information (IMAGEx) the orientation (O_{display}) of the display, relative to the orientation (O_{info}) of the information (INFO) shown on the display is arranged to be defined and
means for changing the orientation (O_{info}) of the information (INFO) shown on the display to the target orientation (O_{itgt}) set for it, if the orientation (O_{display}) of the display and the orientation (O_{info}) of the information (INFO) shown on the display differ from each other in a set manner,
characterized in that the definition of the display is arranged to be performed at intervals, in such a way that the camera means are arranged to form image information (IMAGEx) for the purpose of definition of the orientation less frequently, relative to their continuous viewfinder detection frequency.

14. A device according to claim 13, characterized in that the definition of the orientation is arranged to be performed at intervals of 1-5 seconds, for example, intervals of 2-4 seconds, preferably intervals of 2-3 seconds.

15. A device according to claim 13, characterized in that 30-95%, for example, 50-80%, however, preferably less than 90% of the device resources are arranged to be used for the definition of the orientation.

16. A device according to any of claim 13, characterized in that at least two users are arranged to be detected from the image information (IMAGEx), from the facial features of whom an average value is arranged to be defined, on the basis of which the orientation (O_{display}) of the display is arranged to be defined.

17. Software means for implementing the method according to claim 1, in which are arranged operationally in connection with the display
camera means enabling at least viewfinder imaging for forming image information (IMAGEx), image information (IMAGEx) is arranged to be analysed using by the software means applying one or more selected algorithms for defining the orientation (O_{display}) of the display, relative to the orientation (O_{info}) of the information (INFO) shown on the display,
software means for changing the orientation (Oinfo) of the information (INFO) shown on the display to the target orientation (O_{itgt}) set for it, if the orientation (O_{display}) of the display and the orientation (O_{info}) of the information (INFO) shown on the display differ from each other in a set manner,
characterized in that the software means for defining the orientation (O_{display}) of the display and, on its basis for setting the orientation (O_{info}) of the information (INFO), are arranged to perform at intervals, in such a way that the camera means are arranged to form image information (IMAGEx) for the purpose of the definition of the orientation less frequently, relative to their continuous viewfinder detection frequency.

18. Software means according to claim 17, characterized in that a facial-feature analysis is arranged to be used in the definition of the orientation.

19. Software means according to claim 17, characterized in that the definition of the orientation is arranged to be performed at intervals of 1-5 seconds, for example, intervals of 2-4 seconds, preferably intervals of 2-3 seconds.

20. Software means according to claim 17, characterized in that 30-95%, for example, 50-80%, however, preferably less than 90%, of the device resources are arranged to be reserved for the definition of the orientation.

21. Software means according to claim 17, characterized in that at least two users are arranged to be detected from the image information (IMAGEx), from the facial features of whom an average value is arranged to be defined, on the basis of which the orientation (O_{display}) of the display is arranged to be defined.
